(19) United States
(12) Patent Application Publication
(10) Pub. No.: US 2024/0086969 A1
(43) Pub. Date: Mar. 14, 2024

(54) VISUAL MEDIA PERSONALIZATION BASED UPON USER CHARACTERISTIC

(71) Applicant: Lenovo (United States) Inc., Morrisville, NC (US)

(72) Inventors: Mark Delaney, Raleigh, NC (US); Nathan Peterson, Oxford, NC (US); John C Mese, Cary, NC (US); Arnold Weksler, Raleigh, NC (US); Russell Speight VanBlon, Raleigh, NC (US)

(21) Appl. No.: 17/940,663

(22) Filed: Sep. 8, 2022

(51) Int. Cl. G06Q 30/02

(52) U.S. Cl. CPC G06Q 30/0269

(57) ABSTRACT

One embodiment provides a method, including: receiving, at an information handling device, input from a user to display at least one piece of visual media comprising a plurality of media elements; identifying, using the media characterization system, at least one characteristic of the user; and dynamically changing, utilizing the media characterization system, at least one of the plurality of media elements to another media element option, wherein the another media element option is correlated to the user based upon the at least one characteristic. Other aspects are claimed and described.

### BACKGROUND

Intuitive marketing allows for a company to access personal user data (e.g., purchasing collected personal data, permitting access to social media accounts, accessing cookies, etc.) in order to hone in on potential customer. This marketing strategy may direct specific products and/or marketing styles to capture the attention of a potential customer in hopes of converting a sale. For example, a man who is known to be a football fan may receive ads related to their favorite team's gear and/or may be presented with ads based around the central concept of football. Marketing based upon collected personal data will ultimately draw the interest of the potential customer.

### BRIEF SUMMARY

In summary, one aspect provides a method, including: receiving, at an information handling device, input from a user to display at least one piece of visual media comprising a plurality of media elements; identifying, using the media characterization system, at least one characteristic of the user; and dynamically changing, utilizing the media characterization system, at least one of the plurality of media elements to another media element option, wherein the another media element option is correlated to the user based upon the at least one characteristic.

Another aspect provides an information handling device, including: a processor; a memory device that stores instructions that when executed by the processor, causes the information handling device to: receive input from a user to display at least one piece of visual media comprising a plurality of media elements; identify, using the media characterization system, the at least one characteristic of the user; and dynamically change, utilizing the media characterization system, at least one of the plurality of media elements to another media element option, wherein the another media element option is correlated to the user based upon the at least one characteristic.

A further aspect provides a product, the product including: a computer-readable storage device that stores executable code that, when executed by a processor, causes the product to: receive, at an information handling device, input from a user to display at least one piece of visual media comprising a plurality of media elements; identify, using the media characterization system, the at least one characteristic of the user; and dynamically change, utilizing the media characterization system, at least one of the plurality of media elements to another media element option, wherein the another media element option is correlated to the user based upon the at least one characteristic.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method for dynamically changing at least one media element in a piece of visual data by use of a media characterization system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

With the ability to collect user personal data in many different forms, marketing products to a potential customer has become more specific and personalized. As mentioned previously in the example for a man who is known to enjoy football, a marketing system can now identify characteristics of a potential customer and thereafter customize the ads in which they encounter. Traditionally, ads were received utilizing more generic methods (e.g., television, newspaper ads, sides of busses, billboards, etc.). These generic marketing methods were viewed by all; thus, a marketing strategy that was acceptable for all was implemented. These ads commonly included family-friendly approaches to ascertain that what was being viewed by everyone, from young children to adults, and is not too specific to a particular sub-group of people. Thus, the marketed products must also be products that may be purchasable by a large majority of the population.

As marketing methods have evolved with the use of social media and the creation of user internet profiles, marketing has become more customer specific. Social media accounts allow users to specifically follow things, topics, people, and/or the like, that are interesting to the specific user. A user may elect to follow and/or view topics that interest them, while simultaneously ignoring topics that do not draw their interest. In reference to the previous example, a man who enjoys football may follow and/or view multiple football-based profiles and/or web pages a day. This can assist in establishing that this user is a football fan. On the contrary, this football fan may not follow and/or have an interest in the latest fashion trends. This can be established by a marketing system and/or company recognizing that the man does not follow and/or view of profiles and/or pages that discuss fashion trends (which there are an exponential amount of). From this collection of information, the ads and/or products marketed toward this man will include football related products (e.g., gear, tickets, sports bars, etc.) and will withhold any ads that would be directed at fashion trends.

An issue with this type of intuitive marketing based upon user collected data is that not all products in which a potential customer is researching will fall into a specific subcategory and/or under a specific characteristic generated from previously collected data. For example, the male football fan that does not keep up with the latest fashion trends will still view potential needs that all potential customers need. These products may include furniture, toiletries, office products, and the like. A marketing system and/or company can track and record the viewing of these products by potential customers; however, these products can fall outside user specific subcategories previously established for the potential customer. Therefore, these products being viewed by the potential customer will be seen as generic, once again. Thus, what is needed is a system and method that may dynamically change a characteristic within an ad to capture the interest of the user viewing the product.

Accordingly, the described system and method provides a technique for identifying at least one characteristic of the user providing input to display a piece of visual media and thereafter dynamically changing at least one media element within the visual media by use of a media characterization system correlating the change in the at least one media element to at least one characteristic of the user. While accessing visual media data through an information handling device, the system may receive an input from the user to display at least one piece of visual media data comprising a plurality of elements. This plurality of elements may include primary content of the visual media, as well as secondary content elements that do not influence the primary content of the visual media (e.g., background elements, supports elements, etc.).

After receiving the input from the user, the media characterization system may then identify at least one characteristic of the user that may be beneficial in influencing the visual media selected. From this identification of the at least one characteristic, the media characterization system may elect to dynamically change at least one of a plurality of media elements present in the visual media to another media element option that correlates the dynamically changed portion of the visual image to at least one characteristic of the user. Such a method provides a user with a dynamically changed piece of visual media that has since been adjusted to be directed at the user.

The illustrated example embodiments will be best understood by reference to the figures. The following description is intended only by way of example, and simply illustrates certain example embodiments.

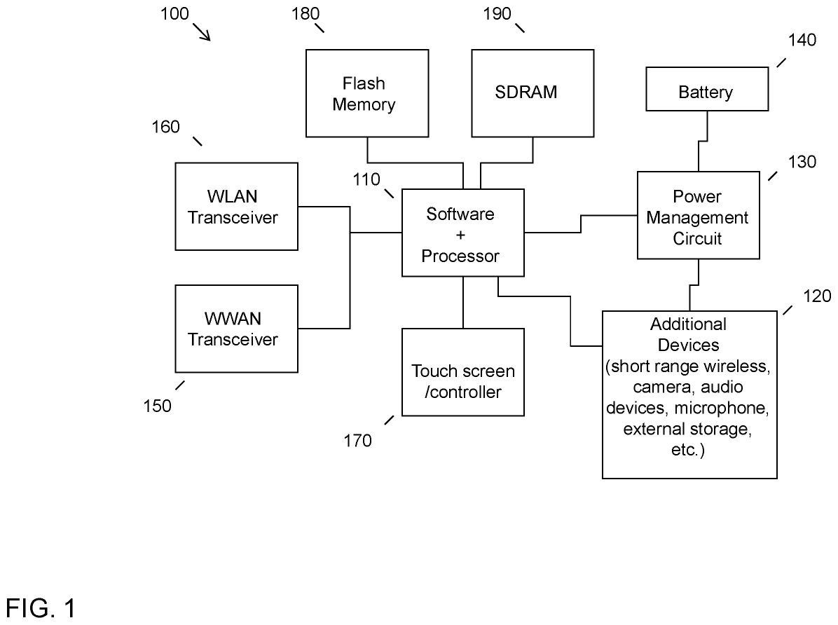

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, input/output (I/O) ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use serial advanced technology attachment (SATA) or peripheral component interconnect (PCI) or low pin count (LPC). Common interfaces, for example, include secure digital input/output (SDIO) and inter-integrated circuit (I2C).

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply basic input/output system (BIOS) like functionality and dynamic random-access memory (DRAM) memory.

System 100 typically includes one or more of a wireless wide area network (WWAN) transceiver 150 and a wireless local area network (WLAN) transceiver 160 for connecting to various networks, such as telecommunications networks and wireless Internet devices, e.g., access points. Additionally, devices 120 are commonly included, e.g., a wireless communication device, external storage, etc. System 100 often includes a touch screen 170 for data input and display/rendering. System 100 also typically includes various memory devices, for example flash memory 180 and synchronous dynamic random-access memory (SDRAM) 190.

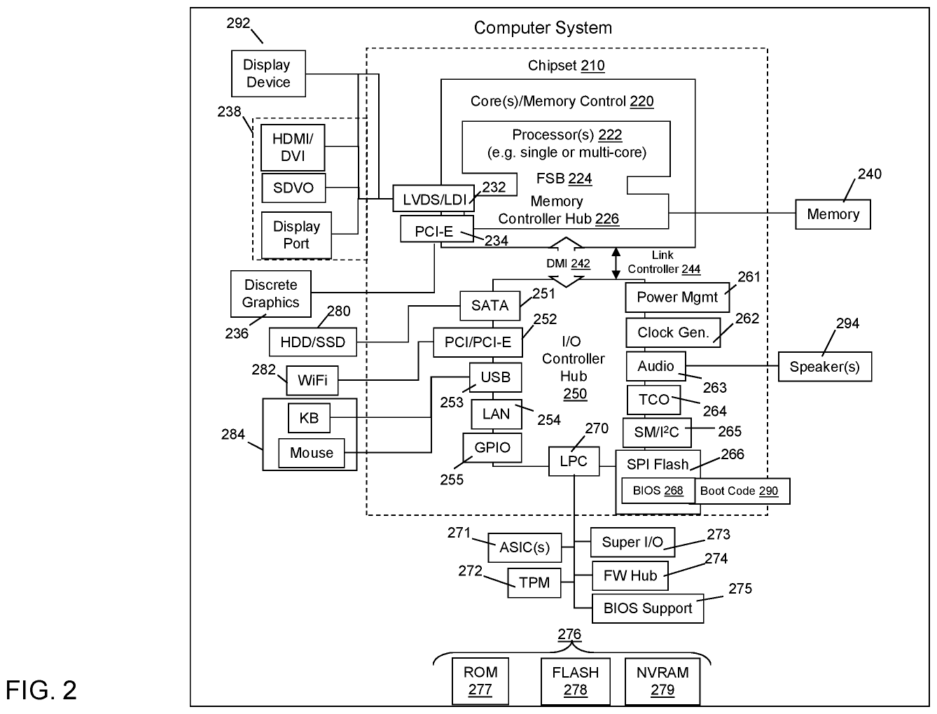

FIG. 2 depicts a block diagram of another example of information handling device circuits, circuitry or components. The example depicted in FIG. 2 may correspond to computing systems such as personal computers, or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of random-access memory (RAM) that may be referred to as “system memory” or “memory”). The memory controller hub 226 further includes a low voltage differential signaling (LVDS) interface 232 for a display device 292 (for example, a cathode-ray tube (CRT), a flat panel, touch screen, etc.). A block 238 includes some technologies that may be supported via the low-voltage differential signaling (LVDS) interface 232 (for example, serial digital video, high-definition multimedia interface/digital visual interface (HDMI/DVI), display port). The memory controller hub 226 also includes a PCI-express interface (PCI-E) 234 that may support discrete graphics 236.

In FIG. 2, the I/O hub controller 250 includes a SATA interface 251 (for example, for hard-disc drives (HDDs), solid-state drives (SSDs), etc., 280), a PCI-E interface 252 (for example, for wireless connections 282), a universal serial bus (USB) interface 253 (for example, for devices 284 such as a digitizer, keyboard, mice, cameras, phones, microphones, storage, other connected devices, etc.), a network interface 254 (for example, local area network (LAN)), a general purpose I/O (GPIO) interface 255, a LPC interface 270 (for application-specific integrated circuit (ASICs) 271, a trusted platform module (TPM) 272, a super I/O 273, a firmware hub 274, BIOS support 275 as well as various types of memory 276 such as read-only memory (ROM) 277, Flash 278, and non-volatile RAM (NVRAM) 279), a power management interface 261, a clock generator interface 262, an audio interface 263 (for example, for speakers 294), a time controlled operations (TCO) interface 264, a system management bus interface 265, and serial peripheral interface (SPI) Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as tablets, smart phones, personal computer devices generally, and/or electronic devices, which may be used in a system that receives input from a user to display visual media with a plurality of media elements and/or identifies at least one characteristic of a user. For example, the circuitry outlined in FIG. 1 may be implemented in a tablet or smart phone embodiment, whereas the circuitry outlined in FIG. 2 may be implemented in a personal computer embodiment.

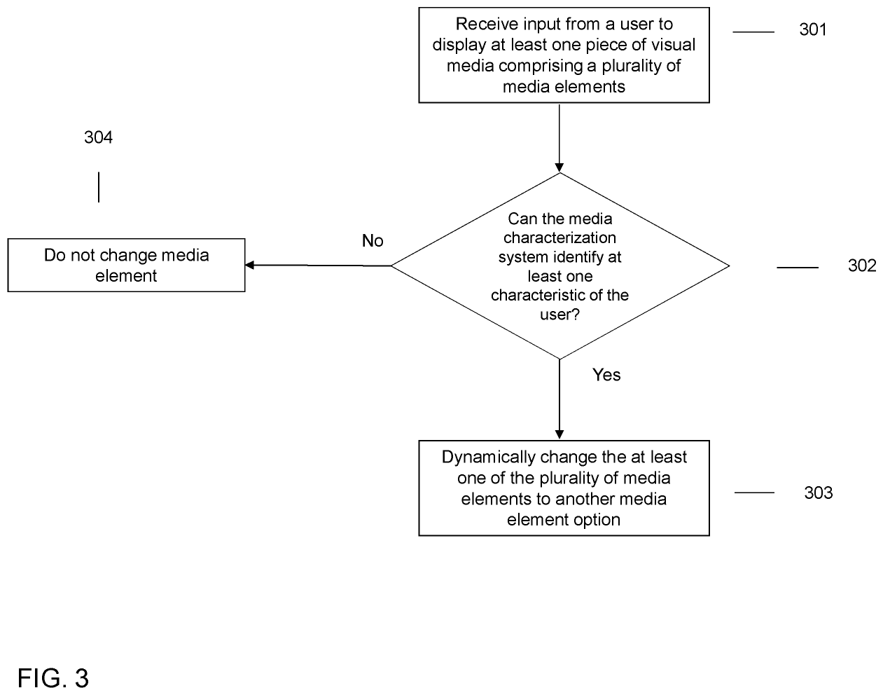

FIG. 3 illustrates an example method for identifying at least one characteristic of the user and dynamically changing at least one of a plurality of media elements to another media element option that correlates with the at least one characteristic by use of a media characterization system. The method may be implemented on a system which includes a processor, memory device, output devices (e.g., display device, etc.), input devices (e.g., keyboard, touch screen, mouse, microphones, sensors, biometric scanners, etc.), and/or other components, for example, those discussed in connection with FIG. 1 and/or FIG. 2. While the system may include known hardware and software components and/or hardware and software components developed in the future, the media characterization system itself is specifically programmed to perform the functions as described herein to dynamically adjust a media element found in visual media.

The media characterization system may run in the background of an information handling device and may be activated when the device is activated. Additionally, or alternatively, the system may be activated when an application associated with a consumer application (e.g., shopping website, shopping application, etc.) is activated, detected, or otherwise opened. The system may also activate the system upon the receipt of user input to display a piece of visual media. In this case, the media characterization system may not be activated until the input from the user to view visual media is received.

Once the media characterization system is activated on a device, the system may be utilized throughout the process of identifying at least one characteristic of the user. Continued use of the media characterization system in identifying potential characteristics when displaying the visual media will train the device in dynamically changing at least one of the plurality of media elements to another element option that is correlated to the user based upon the at least one characteristic. To perform the described steps and in order to accurately identify at least one characteristic of the user, the media characterization system may utilize a neural network, machine-learning model, and/or other learning algorithm, collectively referred to as a machine-learning model for ease of readability.

The machine-learning model can be trained utilizing characteristics previously recorded, and each of the characteristics associated with a user to be accessible by companies to direct specific marketing strategies at a user, and displaying visual media selected by the user. In other words, the machine-learning model is given access to previously established user characteristics describing interests of the user, and that are already labeled and annotated. Additionally, the machine-learning model receives annotated pieces of visual media that have been parsed based upon elements present within the media. These established user characteristics and annotated pieces of visual media are referred to as a training dataset. A machine-learning model may also be trained to identify different media elements within the visual media, for example, primary media elements, background media elements, supporting media elements, and/or the like.

Using the training dataset, which may change over time, the machine-learning model learns nuances between media elements within pieces of visual media which may then be correlated with characteristics of a user. This results in more accurately identifying media elements and potential user characteristics in each piece of visual media that passes through the media characterization system. For example, the machine-learning model can learn which media elements that occur most frequently and recognize media elements in the visual media that are commonly correlated to user characteristics. As information is determined within a piece of visual media, the machine-learning model can learn additional nuances and become more accurate and refined over time. Thus, while there is an initial training dataset that is used to initially train the machine-learning model, the machine-learning model is learning over time based upon new information received by the machine-learning model, thereby evolving to become more accurate.

At 301, while an information handling device is in use, the system may receive input from a user to display at least one piece of visual media containing a plurality of media elements. In the system, receiving input from a user may include selecting a piece of media on a website, selecting a piece of media within an application installed on the information handling device, and/or the like. Upon receiving the user input, at 301, the information handling device in use (e.g., a smartphone, laptop computer, tablet, smart watch, smart TV, etc.) may display the piece of visual media selected. In the system, and based upon an application and/or program in use, input from the user may display more than one piece of visual media selected. When displaying the visual media, the information handling device may employ a graphical display, either integrally or operatively coupled to the information handling device, to differentiate the piece of visual media from additional pieces of media present. For example, if a user is viewing a shopping application on their smartphone, a grid-type layout may be present on the application, showcasing a variety of t-shirts. Each cell of the grid-type layout may contain a single piece of visual media (e.g., a single t-shirt), and upon receiving input from a user to display, at 301, a selected t-shirt, the system may present the selected t-shirt to the user. As mentioned previously, in the system, a user input may select more than one piece of visual media and display these pieces of visual media simultaneously.

The at least one piece of visual media may contain a plurality of media elements. A media element may correspond to each object, person, landmark, and/or other elements, within the image. A media element may also correspond to elements of the media that have been defined by a creator of the visual media. In this case, the elements may include multiple objects, people, landmarks, and/or the like. For example, a creator may define a foreground as a single media element regardless of the number of elements within the foreground. Similarly, the creator may define a background as a single media element. The media elements, including those that may include multiple elements, may also be defined or identified by the media characterization system.

Media elements may consist of each recordable element present in the piece of visual media. For example, continuing the previous example of accessing a catalog of t-shirts through an application on the information handling device of the user, the media elements may include the primary content of the visual media (e.g., the t-shirt) and additional media elements other than the primary content, herein referred to as secondary content. The secondary content, or at least one media element other than the primary content, includes any additional elements present in the piece of visual media. Continuing the previous example, if the t-shirt is the primary content of the visual media, then the clothing rod that the t-shirt is hanging from, the background image/color of the visual media, the hanger attaching the t-shirt to the clothing rod, and the like, may be considered secondary content.

As marketing products to individuals has become more routine, setting a scene surrounding a product has grown increasingly common. When setting a scene, a marketing company, and/or division of a larger entity, may produce a scene that accents the primary content of the visual media and allows a user to more easily imagine themselves using, within, engaging with, and/or the like, the primary content. In setting such a scene, the piece of visual media may include an exuberant backdrop for a smaller piece of primary content. For example, if a company is attempting to sell a t-shirt with a surfer on it, the visual piece of media may include media elements such as a surfboard, a palm tree with coconuts, and a beach background image. The t-shirt is the primary content, and the additional media elements of the surfboard, palm tree with coconuts, and beach background may be the secondary content, or the media elements other than the media elements related to the primary content. In the system, the plurality of media elements makeup the single piece of visual media.

After receiving the input from the user, at 301, the system may determine, at 302, if the media characterization system can identify at least one characteristic of the user. In the system, identifying a user characteristic of the user, at 302, may indicate a current state of the user and/or a preference of the user. Capturing the characteristic of the user may include utilizing one or more sensors operatively coupled to the information handling device to obtain user characteristic information. In the system, this type of environmental characteristic identification may include determining a geographic location of the user, a current state of the user, an environment of the user, and/or the like. The environmental characteristic of the user may influence a preference and/or characteristic of the user.

Further, when identifying a user characteristic by use of the media characterization system, at 302, the system may identify an interest characteristic of the user which indicates things, people, places, ideas, and/or the like, the user likes. To identify an interest characteristic the media characterization system may access at least one linked account corresponding to the user. Accessing a linked account, for example, a social media account, user profile account, affiliated group account, shopping account, and/or the like, may provide the system with user content information, which may then be analyzed to determine interests of the user. Such user interest characteristics may be ascertained from profiles and/or webpages that a user follows and/or frequently visits, likes, favorites, and/or the like.

In a similar vein, utilizing a media characterization system to identify at least one characteristic of the user, at 302, the system may determine an interest of the user based upon a user specific algorithm. The media characterization system may gain access to a variety of user describing components (e.g., social media accounts, shopping accounts, profiles, etc.), and used in combination with the machine-learning model, the media characterization system may accept user data from the variety of components to determine a user characteristic. For example, when utilizing the media characterization system, user data described within linked accounts, cookies on a personal information handling device, geographic location of the user, additional user input, and the like, may be accepted and pushed through a user specific algorithm to determine at least one user characteristic.

As an example, the media characterization system may access a user's linked social media account and determine that the user follows a variety of football-based accounts. Similarly, when the system accesses the cookies on the personal device of the user, a variety of football related articles are determined to have been viewed. Additionally, for example, the media characterization system may access geographic information of the user to determine that the user works and lives in southwestern Pennsylvania. Thereafter, by use of the media characterization system utilizing a user specific algorithm, weighing the obtained user specific algorithm may conclude that this user from southwestern Pennsylvania that loves football is a Pittsburgh Steelers fan. Thus, the user characteristic produced by the user specific algorithm of the media characterization system describes the user as a fan of the Pittsburgh Steelers.

In the system, after determining that the media characterization system can identify at least one characteristic of the user, at 302, the media characterization system may classify any characteristics found into a subgroup of users having matching characteristics. These subgroups of user characteristics will be similar in a sense that they touch on the same topics; however, the characteristics themselves may not be exactly the same. For example, as established previously, a user may be identified as a Pittsburgh Steelers fan. An additional user may also be identified as a football fan; however, the media characterization system may deem this additional user as a Dallas Cowboys fan. Clearly these are two different professional football organizations, and even though their fans would never say they are similar, this characteristic of football fandom may be placed together in the same subgroup. In other words, in the system, the subgroup in which a user characteristic is classified into may be at a higher-level over being highly-specific.

Identifying a user characteristic, such as a football team fandom, may thereafter be used when dynamically changing the at least one of the plurality of media elements to another media element 303. However, when a situation arises that the media characterization system cannot identify at least one characteristic of the user, at 302, then the system will elect to not change a media element, as shown at 304. Whether it be from a lack of user accessible data, poor network service for supplying geographic data, or the like, a situation may arise that does not permit the media characterization system to identify a user characteristic at 302, and will not change a media element, at 304. The user may also refuse to allow the media characterization system to access information that allows the system to identify a user characteristic. The user can also configure the media characterization system to identify when the system can identify a characteristic. For example, the user may indicate that characteristics can only be identified for particular applications, websites, during certain times, at certain environments (e.g., work vs. home), and/or the like.

Alternatively, when it is determined that the media characterization system can identify at least one characteristic of the user, at 302, the system may move forward with dynamically changing at least one of the plurality of media elements to another media element option, at 304. In the system, when dynamically changing the at least one media element found in the piece of visual media, at 303, the media element is being changed to correlate to the user based upon the at least one characteristic produced by the media characterization system. In the system, the primary content of the selected piece of visual media may not be dynamically changed; however, the secondary content, or the other media elements present in the visual media may be dynamically adjusted. It should be noted that some changeable media elements may overlay the primary content.

Now, in the system, when utilizing the media characterization system to dynamically change at least one of the plurality of media elements to another media element option, at 303, and the new media element option is correlated to the user based on the at least one characteristic, the media characterization system may determine which of the media element options may be changed. In other words, after determining that a user characteristic may be implemented into a piece of visual media based on a correlation between a media element in the identified user characteristic, the system may change the media element from an original media element to an updated or new media element with the user characteristic. In the system, the another media element to be changed, or a piece of secondary content within the visual media, may be selected based on what is present in the visual media. Additionally, or alternatively, in the system, the another media option may be selected from a preset plurality of media element options. In other words, the media element options that may be changed are predetermined. This may be a result of commonality of media element options present in visual media outside the primary content.

When the media element to be dynamically changed from the original media element to the new media element option is selected, the system may overlay the new media element option over the original media element that is being changed. In the system, rather than removing and replacing a media element with the new media element comprising the user characteristic, overlaying the new media element onto the visual media may require less time and less power than fully replacing the media element. Additionally, or alternatively, overlaying another media element may be easily removed, permitting the original media element to remain intact and utilized when a separate user is viewing the visual media. On the other hand, the media element may be removed and replaced with the new media element. It should be noted that secondary content to be changed may be simply a background color, an open space within the visual media, and/or the like. In other words, the media element to be changed may not be an element at all, and the replacing may be adding the media element into the visual media, changing a pattern and/or color of a media element, and/or the like.

As an example, in combination with the previously recited examples, if a user who is determined to be a football fan, specifically, a Pittsburgh Steelers fan, is viewing a piece of visual media containing the primary content of a t-shirt but secondary content is also present in a scene, the media characterization system may determine which of the media elements present in the scene surrounding the primary content of the t-shirt may be dynamically changed. In the system, the plurality of media elements within the visual media that is available for change may be predefined. If the scene contains a model wearing the primary content, in this case the t-shirt, but is also wearing pants and a hat, the pants and the hat are not considered primary content and may be dynamically changed. Continuing the example, when the media characterization system recognizes that the hat in which the model is wearing consists of a football team, but does not coincide with the user characteristics, the media characterization system may overlay a hat with a Pittsburgh Steelers logo onto the model rather than presenting the user with a model with a different hat on. Further, and used as an example, if the model is standing in the middle of football stadium, and the concentration of the visual media is on the t-shirt as the primary content, the media characterization system may overlay a background of Heinz Field (e.g., home of the Pittsburgh Steelers) onto the visual media.

All of these changes to another media element option will not influence the primary content of the visual media, and may further entice a user to purchase the product. In the media characterization system, the machine-learning component may include use of a content analysis technique. Such a content analysis technique may identify potential media elements to be dynamically changed, while simultaneously recording the primary content of the visual media. Therefore, the examples presented previously, seemingly utilize a content analysis technique in combination with machine-learning to accurately and dynamically change at least one media element to another media element that correlates to at least one user characteristic.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
receiving, at an information handling device, input from a user to display at least one piece of visual media comprising a plurality of media elements, wherein each of the plurality of media elements correspond to image elements within the at least one piece of visual media, wherein at least a portion of the plurality of media elements are identified as secondary content;
identifying, using a media characterization system of the information handling device, at least one characteristic of the user; and
dynamically changing, utilizing the media characterization system, at least one of the plurality of media elements identified as the secondary content to another media element option, wherein the another media element option is correlated to the user based upon the at least one characteristic, wherein the dynamically changing comprises overlaying the another media element option over the at least one of the plurality of media elements identified as secondary content.

2. The method of claim 1, wherein the identifying comprises classifying the user into a subgroup of users having at least one matching characteristic and wherein the another media element option is correlated to the at least one matching characteristic.

3. The method of claim 1, wherein the another media option is selected from a preset plurality of media options.

4. (canceled)

5. The method of claim 1, wherein the dynamically changing comprises identifying at least one of the plurality of media elements corresponding to primary content of the at least one piece of visual media data; and
wherein the secondary content comprises a media element other than the at least one of the plurality of media elements corresponding to primary content.

6. The method of claim 5, wherein the identifying at least one of the plurality of media elements corresponding to primary content comprises utilizing a content analysis technique.

7. The method of claim 1, wherein the plurality of media elements available for changing within the at least one piece of visual media are predefined.

8. The method of claim 1, wherein the user characteristic comprises a geographic location of the user.

9. The method of claim 1, wherein the identifying the at least one characteristic comprises accessing at least one linked account corresponding to the user.

10. The method of claim 1, wherein the user characteristic comprises at least one determined interest of the user identified utilizing a user specific algorithm.

11. An information handling device, comprising:
a processor;
a memory device that stores instructions that when executed by the processor, causes the information handling device to:
receive input from a user to display at least one piece of visual media comprising a plurality of media elements, wherein each of the plurality of media elements correspond to image elements within the at least one piece of visual media, wherein at least a portion of the plurality of media elements are identified as secondary content;
identify, using a media characterization system of the information handling, the at least one characteristic of the user; and
dynamically change, utilizing the media characterization system, at least one of the plurality of media elements to another media element option, wherein the another media element option is correlated to the user based upon the at least one characteristic, wherein the dynamically changing comprises overlaying the another media element option over the at least one of the plurality of media elements identified as secondary content.

12. The information handling device of claim 11, wherein the identifying comprises classifying the user into a subgroup of users having at least one matching characteristic and wherein the another media element option is correlated to the at least one matching characteristic.

13. The information handling device of claim 11, wherein the another media option is selected from a preset plurality of media options.

14. (canceled)

15. The information handling device of claim 11, wherein the dynamically changing comprises identifying at least one of the plurality of media elements corresponding to primary content of the at least one piece of visual media data; and
wherein the secondary content comprises a media element other than the at least one of the plurality of media elements corresponding to primary content.

16. The information handling device of claim 15, wherein the identifying at least one of the plurality of media elements corresponding to primary content comprises utilizing a content analysis technique.

17. The information handling device of claim 11, wherein the plurality of media elements available for changing within the at least one piece of visual media are predefined.

18. The information handling device of claim 11, wherein the user characteristic comprises a geographic location of the user.

19. The information handling device of claim 11, wherein the identifying the at least one characteristic comprises accessing at least one linked account corresponding to the user.

20. A product, the product comprising:
a computer-readable storage device that stores executable code that, when executed by the processor, causes the product to:
receive, at an information handling device, input from a user to display at least one piece of visual media comprising a plurality of media elements, wherein each of the plurality of media elements correspond to image elements within the at least one piece of visual media, wherein at least a portion of the plurality of media elements are identified as secondary content;
identify, using a media characterization system of the information handling device, at least one characteristic of the user; and
dynamically change, utilizing the media characterization system, at least one of the plurality of media elements to another media element option, wherein the another media element option is correlated to the at least one matching characteristic, wherein the dynamically changing comprises overlaying the another media element option over the at least one of the plurality of media elements identified as secondary content.
